(19) United States
(12) Patent Application Publication
(10) Pub. No.: US 2026/0233523 A1
(43) Pub. Date: Aug. 13, 2026

(54) LIQUID DISCHARGE HEAD AND IMAGE FORMING APPARATUS

(71) Applicants: Sayuri KOJIMA, Kanagawa (JP); Tomoaki MURAKAMI, Kanagawa (JP)

(72) Inventors: Sayuri KOJIMA, Kanagawa (JP); Tomoaki MURAKAMI, Kanagawa (JP)

(21) Appl. No.: 19/461,782

(22) Filed: Jan. 28, 2026

(30) Foreign Application Priority Data
Feb. 13, 2025 (JP) 2025-021583

(51) Int. Cl. B41J 2/14

(52) U.S. Cl. CPC B41J 2/14274; B41J 2/1433; B41J 2002/14306; B41J 2002/14419

(57) ABSTRACT

A liquid discharge head includes: a nozzle plate having a nozzle configured to discharge liquid in a discharge direction; a channel plate over the nozzle plate, the channel plate having: a pressure chamber; multiple flow restrictors: each communicating with the pressure chamber common to each of the multiple flow restrictors; overlapped with each other in the discharge direction; and each having a same length in a longitudinal direction orthogonal to the discharge direction; an individual chamber communicating with the pressure chamber through the multiple flow restrictors; and a pressure generator configured to generate pressure in the pressure chamber.

### CROSS-REFERENCE TO RELATED APPLICATIONS

This patent application is based on and claims priority pursuant to 35 U.S.C. § 119(a) to Japanese Patent Application No. 2025-021583, filed on Feb. 13, 2025, in the Japan Patent Office, the entire disclosure of which is hereby incorporated by reference herein.

### BACKGROUND

### Technical Field

The present embodiment relates to a liquid discharge head and an image forming apparatus.

### Related Art

A liquid discharge head is configured such that liquid supplied from a common chamber to a pressure chamber via a flow restrictor or the like is discharged from a nozzle by pressurizing the pressure chamber by a pressure generator.

In such a liquid discharge head, excellent refill characteristics and high stability of a liquid discharge speed and a liquid discharge amount should be realized by appropriately setting a resistance value and an inertance in the flow restrictor.

Due to the restriction of the arrangement space of the liquid discharge head in the liquid discharge apparatus, the height of the flow restrictor has a larger degree of freedom than the width and length of the flow restrictor, and it is relatively easy to change the height of the flow restrictor. However, when the resistance value is changed by changing the height of the flow restrictor, since the value of the inertance is also changed at the same time, it has been difficult to set both the resistance value and the inertance to appropriate values simply by changing the height of the flow restrictor.

### SUMMARY

The present disclosure described herein provides a liquid discharge head includes: a nozzle plate having a nozzle configured to discharge liquid in a discharge direction; a channel plate over the nozzle plate, the channel plate having: a pressure chamber; multiple flow restrictors: each communicating with the pressure chamber common to each of the multiple flow restrictors; overlapped with each other in the discharge direction; and each having a same length in a longitudinal direction orthogonal to the discharge direction; an individual chamber communicating with the pressure chamber through the multiple flow restrictors; and a pressure generator configured to generate pressure in the pressure chamber.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external perspective explanatory view of a liquid discharge head according to an embodiment of the present embodiment;

FIG. 2 is an explanatory cross-sectional view of the liquid discharge head taken along a direction orthogonal to a nozzle array direction;

FIG. 3 is a cross-sectional view taken along line A-A in FIG. 2;

FIG. 4 is a plan view of a nozzle plate, each plate-shaped member constituting a channel plate, and a diaphragm member as viewed from an ink discharge direction;

FIG. 5 is a perspective view illustrating a simple channel for calculating a resistance value of an ink channel;

FIG. 6 is an explanatory cross-sectional view of a liquid discharge head different from the above embodiment taken along a direction orthogonal to a nozzle array direction;

FIG. 7 is a plan view of a first restrictor and a second restrictor as viewed from the ink discharge direction;

FIGS. 8A and 8B are diagrams illustrating an embodiment in which a length of a flow restrictor and a partition length are different, in which FIG. 8A is an explanatory cross-sectional view taken along a direction orthogonal to the nozzle array direction, and FIG. 8B is a plan view of each plate-shaped member constituting a channel plate as viewed from the ink discharge direction;

FIG. 9 is an explanatory plan view of a main part of a liquid discharge apparatus according to an embodiment;

FIG. 10 is an explanatory side view of the main part of the liquid discharge apparatus according to the embodiment;

FIG. 11 is an explanatory plan view of a main part of a liquid discharge unit according to another embodiment; and

FIG. 12 is an explanatory front view of a main part of a liquid discharge unit according to still another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

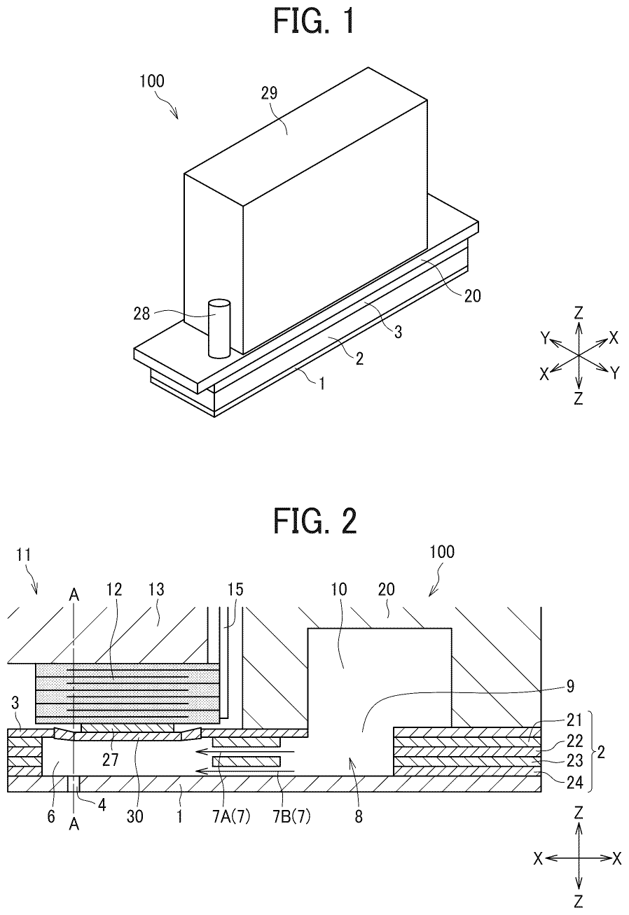

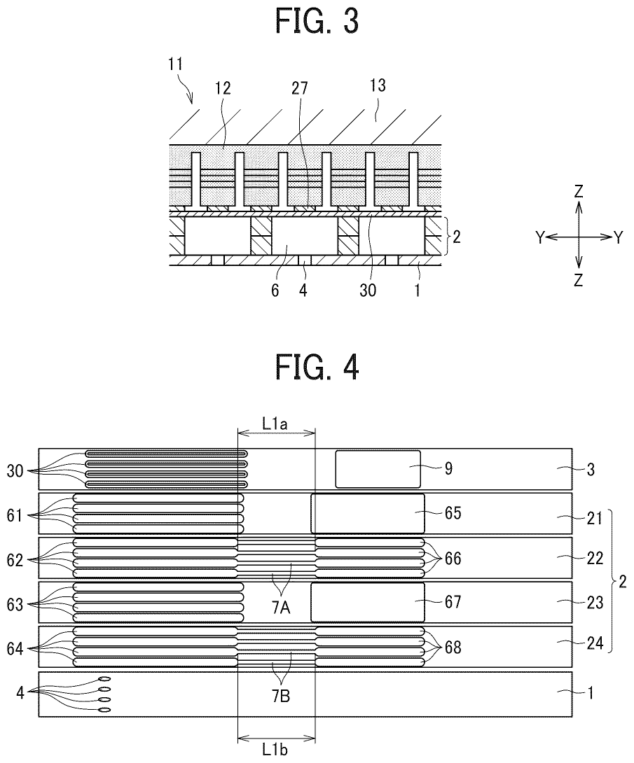

Embodiments of the present embodiment are described below referring to the accompanying drawings. A first embodiment of the present embodiment is described referring to FIGS. 1 to 3. FIG. 1 is an external perspective explanatory view of a liquid discharge head according to the first embodiment, FIG. 2 is an explanatory cross-sectional view of a pressure chamber of the liquid discharge head according to the first embodiment taken along a longitudinal direction X, and FIG. 3 is an explanatory cross-sectional view taken along a nozzle array direction Y. The direction X is also a longitudinal direction of a flow restrictor 7. The direction Y is an array direction of nozzles 4, and is hereinafter also simply referred to as a nozzle array direction. The direction Z is a height direction of a pressure chamber 6, and is an opening direction of the nozzle or a discharge direction and an opposite direction thereof. The direction Z is also a vertical direction. The vertical direction refers to a direction parallel to the gravity direction in a state where the liquid discharge head is used, and the direction in a state where the liquid discharge head is used is, for example, a direction in a state where the liquid discharge head is attached to an apparatus such as a liquid discharge apparatus. The directions X and Y and the direction Z illustrated in FIG. 1 are directions orthogonal to each other. The direction X is different from the nozzle array direction and the vertical direction among the directions orthogonal to each other. However, the direction X which is the longitudinal direction of the pressure chamber 6, the direction Y which is the nozzle array direction, and the direction Z which is the discharge direction may not be strictly perpendicular to each other, and may deviate from the perpendicular with a slight error. The direction Z is not necessarily parallel to the gravity direction.

A liquid discharge head 100 of the present embodiment includes a nozzle plate 1, a channel plate 2 as a channel plate, a diaphragm member 3 serving as a wall surface member, a piezoelectric actuator 11, a common chamber member 20, and a head cover 29. The nozzle plate 1, the channel plate 2, and the diaphragm member 3 are stacked one on another and joined to each other. The piezoelectric actuator 11 displaces a deformable portion 30 of the diaphragm member 3. The head cover 29 also serves as a frame member of the liquid discharge head 100.

A piezoelectric element 12 and the like are disposed inside the common chamber member 20. As illustrated in FIG. 1, the head cover 29 is attached to an upper portion of the common chamber member 20 and covers the piezoelectric element 12 and the like.

Ink as liquid is supplied to a common supply channel in the common chamber member 20 through a supply port 28.

As illustrated in FIGS. 2 and 3, the nozzle plate 1 includes the nozzles 4 from which ink is discharged.

A first flow restrictor 7A and a second flow restrictor 7B, and an intermediate supply portion 8 are defined inside the channel plate 2. The nozzle plate 1, the channel plate 2, and the diaphragm member 3 define multiple pressure chambers 6. The pressure chamber 6 communicates with the nozzle 4. The flow restrictors 7A and 7B are individual channels leading to the pressure chamber 6. In the present embodiment, two flow restrictors 7A and 7B communicate with one pressure chamber 6. The intermediate supply portion 8 is a liquid introduction portion communicating with the flow restrictors 7A and 7B.

The channel plate 2 of the present embodiment is formed by stacking multiple lamination members including a first pressure chamber member 21, a first restrictor 22, a second pressure chamber member 23, and a second restrictor 24. The flow restrictors 7A and 7B are formed of these plate members constituting the channel plate 2. The flow restrictors 7A and 7B are disposed in the vertical direction in FIG. 2. Hereinafter, the flow restrictors 7A and 7B are also referred to as flow restrictors 7. However, the channel plate 2 may be formed of five or more plate members, and three or more flow restrictors 7 may communicate with one pressure chamber 6.

The first restrictor 22 is referred to also as a “first lamination plate”. The second pressure chamber member 23 is referred to also as a “second lamination plate”. The second restrictor 24 is referred to also as a “third lamination plate”.

The diaphragm member 3 includes multiple plates stacked in layers, and in the present embodiment, includes two metal plates stacked in layers. The diaphragm member 3 includes the deformable portion 30 facing the piezoelectric actuator 11.

The deformable portion 30 is a portion that constitutes a part of the wall surface of the pressure chamber 6 and is elastically deformable by the piezoelectric actuator 11. The piezoelectric actuator 11 includes the piezoelectric element 12 that is an electromechanical transducer as a pressure generator (driving means and actuator means) that generates pressure in the pressure chamber 6. The deformable portion 30 of the present embodiment includes fewer plate members than the other portions of the diaphragm member 3 and is thinner than the other portions. Specifically, the deformable portion 30 includes one metal plate. Alternatively, the diaphragm member 3 may be cut out to be partially deformable, and a part of the deformable cutout portion forming the wall surface of the pressure chamber 6 may be used as the deformable portion 30.

In the piezoelectric actuator 11, a piezoelectric member bonded onto a base member 13 is groove-processed by half cut dicing to form a desired number of pillar-shaped piezoelectric elements 12 in a comb shape at predetermined intervals in the nozzle array direction.

A supporting member 27 that supports the deformable portion 30 is provided above the deformable portion 30. The piezoelectric element 12 is bonded to the supporting member 27.

The piezoelectric element 12 includes piezoelectric layers and internal electrodes alternately stacked on each other. In the piezoelectric element 12, each internal electrode is led out to an end face and coupled to an external electrode (end face electrode), and a flexible wiring member 15 is coupled to the external electrode.

The common chamber member 20 forms a common chamber 10 communicating with the plurality of pressure chambers 6. The common chamber 10 communicates with the intermediate supply portion 8 via an opening 9 provided in the diaphragm member 3 and further communicates with the flow restrictors 7A and 7B via the intermediate supply portion 8.

Ink in the common chamber 10 is supplied to the pressure chamber 6 via the intermediate supply portion 8 and the flow restrictors 7A and 7B. The ink in the pressure chamber 6 is discharged from the nozzle 4 to the outside of the liquid discharge head 100. In the pressure chamber 6, the ink supply direction is a direction from the flow restrictors 7A and 7B toward the nozzle 4 in the direction X.

In the liquid discharge head 100, for example, when a voltage applied to the piezoelectric element 12 is lowered below a reference potential (intermediate potential), the piezoelectric element 12 contracts. As the piezoelectric element 12 contracts, the deformable portion 30 deforms toward the piezoelectric element 12. As a result, the volume of the pressure chamber 6 expands, and thus the ink flows into the pressure chamber 6.

Thereafter, as the voltage applied to the piezoelectric element 12 is increased, the piezoelectric element 12 expands in the direction of lamination. As a result, the deformable portion 30 deforms toward the nozzle 4, and thus the volume of the pressure chamber 6 contracts.

Accordingly, the ink in the pressure chamber 6 is pressurized and discharged from the nozzle 4.

FIG. 4 is a plan view of the nozzle plate 1, each plate-shaped member constituting the channel plate 2, and the diaphragm member 3 as viewed from the ink discharge direction.

As illustrated in FIG. 4, a hole (recess) constituting a part of a pressure chamber or the like is formed in each of the first pressure chamber member 21, the first restrictor 22, the second pressure chamber member 23, and the second restrictor 24. Specifically, holes 61, 62, 63, and 64 forming the respective pressure chambers are formed in the first pressure chamber member 21, the first restrictor 22, the second pressure chamber member 23, and the second restrictor 24, respectively. The holes 61 to 64 are stacked in the height direction to form the plurality of pressure chambers 6 (see FIG. 2) corresponding to the nozzles 4.

The holes 62 are also referred to as “first multiple holes”. The holes 63 are also referred to as “fifth multiple holes”. The holes 64 are also referred to as “third multiple holes”.

The first flow restrictor 7A is formed in the first restrictor 22, and the second flow restrictor 7B is formed in the second restrictor 24. The first restrictor 22 is the first lamination member of the present embodiment that forms the flow restrictor 7A. The second restrictor 24 is the third lamination member of the present embodiment that forms the flow restrictor 7B. The second pressure chamber member 23 is the second lamination member of the present embodiment that partitions the flow restrictor 7A and the flow restrictor 7B. The length in the longitudinal direction of the first flow restrictor 7A is L1a, and the length in the longitudinal direction of the second flow restrictor 7B is L1b. The longitudinal direction of the flow restrictor is a right-left direction in FIG. 4, and is a direction in which the liquid mainly flows in the flow restrictor. In the present embodiment, the direction is also a direction leading from the individual liquid chamber to the pressure chamber. By the recesses formed in the first restrictor 22 and the second restrictor 24, the flow restrictor 7A and a first individual chamber 66, or the flow restrictor 7B and a second individual chamber 68 are defined side by side in the longitudinal direction.

The first individual chambers 66 are formed by second multiple holes. The second intermediate supply chamber 67 are formed by one hole. The second individual chambers 68 are formed by fourth multiple holes.

In the first pressure chamber member 21, a first intermediate supply chamber 65 communicating with the common chamber 10 (see FIG. 2) through the opening 9 in the diaphragm member 3 is formed. Each first individual chamber 66 communicating with each first flow restrictor 7A is formed in the first restrictor 22. A second intermediate supply chamber 67 is formed in the second pressure chamber member 23. Each second individual chamber 68 communicating with each second flow restrictor 7B is formed in the second restrictor 24. The first intermediate supply chamber 65 communicates with each first individual chamber 66. The second intermediate supply chamber 67 communicates with each first individual chamber 66 on one side thereof and communicates with each second individual chamber 68 on the other side thereof. The first intermediate supply chamber 65, each first individual chamber 66, the second intermediate supply chamber 67, and each second individual chamber 68 form the intermediate supply portion 8 (see FIG. 2). The intermediate supply portion 8 is a portion that supplies ink from the common chamber 10 to each of the flow restrictors 7A and 7B. As described above, the intermediate supply chamber is a portion communicating with each individual liquid chamber or the common chamber.

Excellent refill characteristics and high stability of the liquid discharge speed and the liquid discharge amount in the liquid discharge head should be realized by appropriately setting a resistance value R and an inertance L in the flow restrictor 7.

Here, the resistance value R of the flow restrictor 7 changes depending on a width w, a length l, a height h, and the like of the flow restrictor 7. However, due to the restriction of the arrangement space of the liquid discharge head in the liquid discharge apparatus, there are large restrictions on the width w and the length l, and the degree of freedom of the set value of the height h is relatively large. However, since both the resistance value R and the inertance L are changed by changing the height h, it has been difficult to set both the resistance value R and the inertance L to appropriate values by changing the height h. For example, it is preferable to reduce the resistance value R from the viewpoint of refill characteristics, but the change in the liquid discharge amount at the time of frequency fluctuation becomes large.

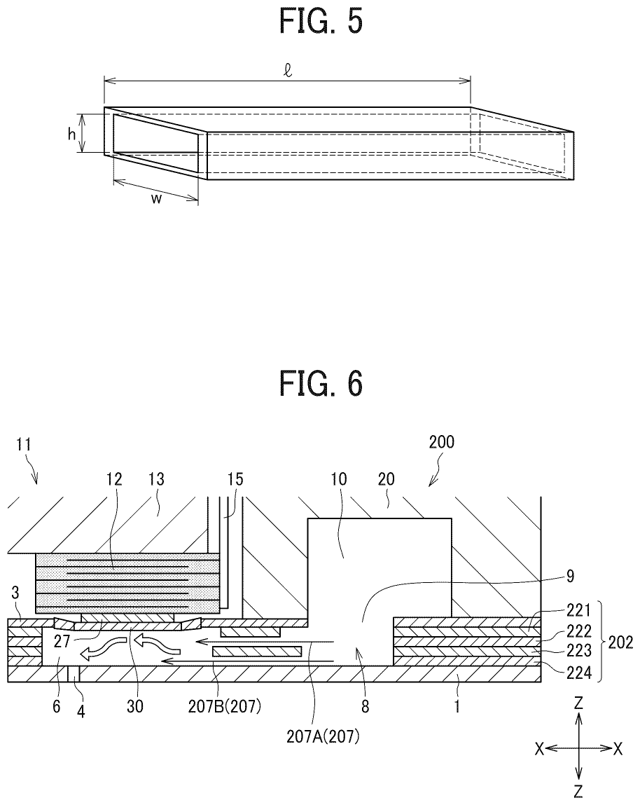

FIG. 5 is a perspective view illustrating a simple channel for calculating a resistance value of a liquid channel such as an ink channel.

When the viscosity, the density, the sound velocity of the ink flowing through the channel of FIG. 5 are denoted by μ, ρ, c, respectively, the resistance value R and the inertance L in the channel of FIG. 5 can be obtained by the following expressions (1) and (2) using these values and the width w, the length l, and the height h of the channel illustrated in FIG. 5.

$$\begin{matrix}[ Math . 1 ] & \\ R = \frac{12 \times μ \times l}{w \times {h}^{3}} \times 1.045 & ( 1 )\end{matrix}$$

$$L = \frac{6 \times ρ \times l}{5 \times h \times w} \qquad ( 2 )$$

In the present embodiment, as illustrated in FIG. 2, the first flow restrictor 7A and the second flow restrictor 7B are provided to communicate with the common pressure chamber 6. As a result, the height h of each of the flow restrictors 7A and 7B can be suppressed to be small, and each of the resistance value R and the inertance L can be adjusted to an appropriate value. The refill characteristics deteriorate as the height h decreases, but the refill characteristics can be improved by the configuration in which the ink is supplied from the multiple flow restrictors to the common pressure chamber 6. Therefore, excellent refill characteristics can be realized, and fluctuations in the liquid discharge speed and the liquid discharge amount can be suppressed. In particular, by suppressing the inertance L to be small according to the present embodiment, it is possible to prevent deterioration of the refill characteristics during high-frequency driving.

In the present embodiment, the flow restrictors 7A and 7B are disposed to overlap each other in the discharge direction. In other words, some or all of the flow restrictors 7A and 7B are disposed to overlap each other as viewed in the discharge direction. The “overlap” may include another member interposed between the flow restrictors as in the present embodiment. By disposing the flow restrictors 7A and 7B in an overlapping manner in the discharge direction in this manner, it is possible to realize a liquid discharge head in which the flow restrictors 7A and 7B are disposed without increasing the size of the liquid discharge apparatus. Thus, it is possible to downsize the liquid discharge apparatus. In the configuration in which the flow restrictors 7A and 7B are disposed side by side in the direction perpendicular to the discharge direction, unless each flow restrictor is formed so as to cleanly penetrate the first pressure chamber member 21, the first restrictor 22, the second pressure chamber member 23, and the second restrictor 24 to be stacked, unevenness is formed at the joint between the layers.

Since the unevenness causes an error in resistance, the resistance value tends to vary, but the configuration in which the flow restrictors 7A and 7B are disposed side by side in the discharge direction as in the present embodiment also has an advantage that such variation can be suppressed. In the present embodiment, in particular, the flow restrictor 7A and the flow restrictor 7B are provided at the same position on a plane perpendicular to the discharge direction.

As in the present embodiment, it is preferable that two flow restrictors 7 communicate with one pressure chamber 6. As compared with a configuration in which three or more flow restrictors 7 communicate with one pressure chamber 6, the number of plate members constituting the channel plate 2 can be reduced, alignment of the plate members is facilitated, and resonance due to misalignment is less likely to occur. When a small amount of liquid is supplied to the pressure chamber 6, it is easy to stably supply the liquid. These effects can be obtained, and the effects of achieving the above-described excellent refill characteristics and suppressing the fluctuation in the liquid discharge speed and the liquid discharge amount can be achieved at the same time.

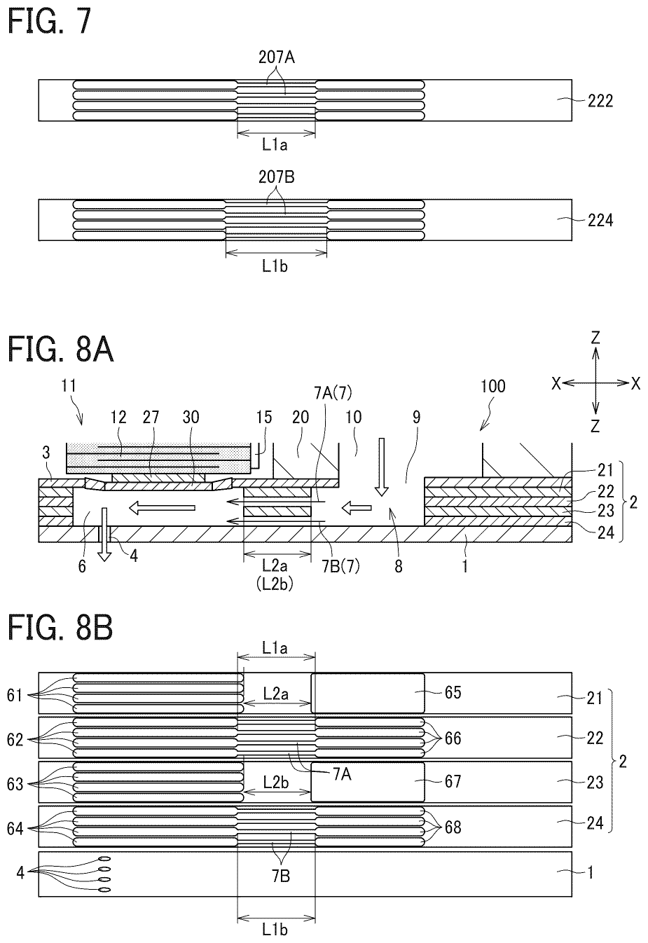

FIG. 6 is an explanatory cross-sectional view of a liquid discharge head different from the present embodiment, taken along a direction orthogonal to a nozzle array direction, and FIG. 7 is a plan view of a first restrictor and a second restrictor as viewed from an ink discharge direction.

In a liquid discharge head 200 illustrated in FIG. 6, the configuration of a channel plate 202, particularly, a first flow restrictor 207A and a second flow restrictor 207B in the channel plate 202 is different from the configuration of the channel plate in the liquid discharge head 100 of FIG. 2 described above, and the configurations of the other portions are basically the same. Specifically, as illustrated in FIG. 7, the length L1a in the longitudinal direction of the first flow restrictor 207A in a first restrictor 222 is different from the length L1b in the longitudinal direction of the second flow restrictor 207B in a second restrictor 224.

The channel plate 202 includes a first pressure chamber member 221 in FIG. 6 corresponding to the first pressure chamber member 21 of FIG. 4 and a second pressure chamber member 223 in FIG. 6 corresponding to the second pressure chamber member 23 of FIG. 4.

Therefore, the liquid supply rates from the flow restrictors 207A and 207B to the pressure chamber 6 are different. That is, the liquid supply rate becomes relatively faster in the second flow restrictor 207B longer than the first flow restrictor 207A. The liquid velocity after passing through the flow restrictors 207 changes depending on the discharge frequency. When the liquid supply rates from the flow restrictors 207 to the pressure chamber 6 are different from each other, the flow of ink fluctuates or bends in the pressure chamber 6 each time a frequency fluctuation occurs. Therefore, the turbulence and vortex as indicated by arrows are likely to occur in the pressure chamber 6 in FIG. 6, and the liquid discharge stability in the liquid discharge head deteriorates, such as an increase in non-ejection of ink.

On the other hand, in the present embodiment, as illustrated in FIG. 4, the length L1a in the longitudinal direction of the first flow restrictor 7A and the length L1b in the longitudinal direction of the second flow restrictor 7B are set to the same length. As a result, even when frequency fluctuation occurs, the liquid supply rates at which ink is supplied from the flow restrictors 7A and 7B to the pressure chamber 6 can be equalized. Therefore, it is possible to suppress the generation of the turbulence and vortex in the pressure chamber 6 as illustrated in FIG. 6 and to improve the liquid discharge stability. However, the length L1a and the length L1b do not necessarily have to be exactly the same dimension. That is, as illustrated in FIG. 6 described above, there is no disadvantage as long as the difference in ink supply rate is such a degree that the turbulence and vortex of the ink in the pressure chamber 6 do not occur, which hinder the discharge stability. Therefore, when the difference is between the length L1a and the length L1b to such an extent that the difference in the ink supply rate occurs, an effect equivalent to a case where the length L1a and the length L1b are exactly the same can be obtained. Specifically, regarding the difference in the ink supply rate, when the difference between the length L1a and the length L1b of the flow restrictors is 10% or less, preferably 5% or less, the same effect as a case where the length L1a and the length L1b are exactly the same can be obtained.

In the present embodiment, both the width (width w) in the direction Y and the width (height h) in the direction Z of the flow restrictors 7A and 7B are smaller than the width of the first individual chamber 66
or the second individual chamber 68 (or the pressure chamber 6). As a result, the channel in the flow restrictor 7 can be narrowed in both the directions Y and Z, and the resistance value R can be further increased. Therefore, in combination with the configuration in which the multiple flow restrictors is provided as in the present embodiment, it is possible to further suppress the fluctuation of the liquid discharge amount particularly at a high frequency while preventing the deterioration of the refill characteristics, which is preferable.

As illustrated in FIGS. 8A and 8B, the length L1a of the first flow restrictor 7A (or the length L1b of the second flow restrictor 7B) is preferably larger than a partition length L2a of the first flow restrictor 7A (or a partition length L2b of the second flow restrictor 7B). As a result, first, the channel width in the direction Y can be narrowed at inlets (right ends of L1a and L1b) of the flow restrictors 7A and 7B, and then the channel width in the direction Z can be narrowed at positions (right ends of L2a and L2b) beyond the first intermediate supply chamber 65 or the second intermediate supply chamber 67. Therefore, the channel resistance can be increased stepwise to stabilize the flow of the liquid, and disturbance of the flow of the liquid can be suppressed.

In the present embodiment, the channel resistance can be similarly reduced stepwise on the outlet side. The partition lengths L2a and L2b are distances between the pressure chamber 6 and the first intermediate supply chamber 65 or the second intermediate supply chamber 67.

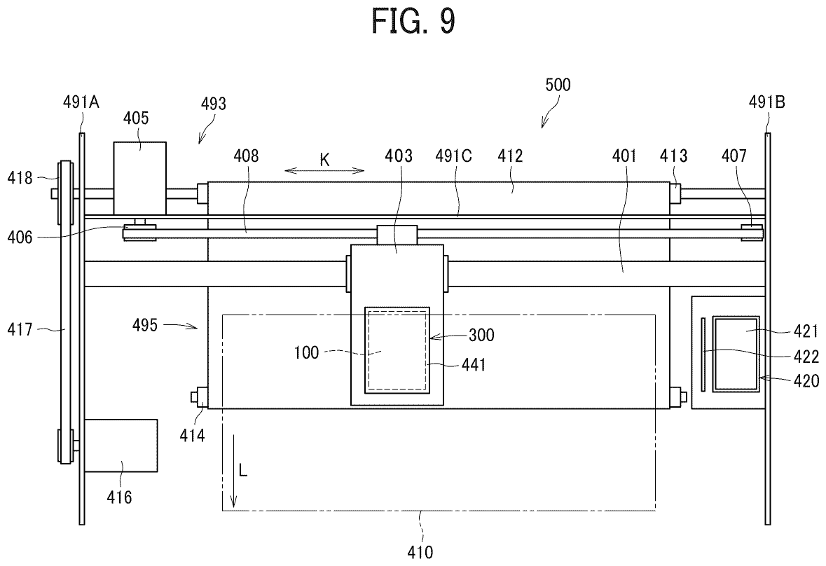

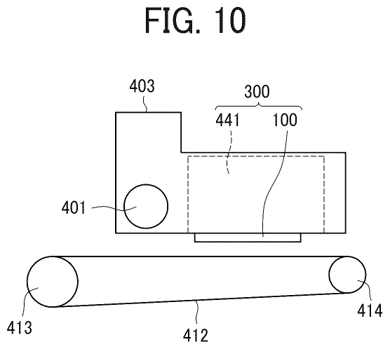

Next, an example of an image forming apparatus according to the present embodiment is described referring to FIGS. 9 and 10.

FIG. 9 is an explanatory plan view of a main part of the image forming apparatus, and FIG. 10 is an explanatory side view of the main part of the image forming apparatus.

A liquid discharge apparatus 500 as an image forming apparatus is a serial type apparatus, and a carriage 403 is reciprocally moved in a main-scanning direction K by a main-scanning moving mechanism 493. The main-scanning moving mechanism 493 includes a guide member 401, a main-scanning motor 405, a timing belt 408, and the like. The guide member 401 is bridged between a left-side plate 491A and a right-side plate 491B to moveably hold the carriage 403. The main-scanning motor 405 reciprocally moves the carriage 403 in the main-scanning direction K via the timing belt 408 bridged between a drive pulley 406 and a driven pulley 407.

A liquid discharge unit 300 in which the liquid discharge head 100 according to the present embodiment and a head tank 441 are integrated is mounted on the carriage 403. The liquid discharge head 100 of the liquid discharge unit 300 discharges liquid of each color, for example, yellow (Y), cyan (C), magenta (M), and black (K). In the liquid discharge head 100, a nozzle array including nozzles are arranged in a sub-scanning direction L orthogonal to the main-scanning direction K, and is mounted with the discharge direction facing downward. Note that, the main-scanning direction K is the direction X in the liquid discharge head described above, and the sub-scanning direction Lis the direction Y in the liquid discharge head described above.

The liquid discharge apparatus 500 includes a conveyance mechanism 495 for conveying a sheet 410. The conveyance mechanism 495 includes a conveyance belt 412 as a conveying means and a sub-scanning motor 416 for driving the conveyance belt 412.

The conveyance belt 412 attracts the sheet 410 and conveys the sheet 410 at a position facing the liquid discharge head 100. The conveyance belt 412 is an endless belt stretched between a conveyance roller 413 and a tension roller 414. Attraction can be performed by, for example, electrostatic attraction or air suction.

The conveyance belt 412 rotates in the sub-scanning direction L as the conveyance roller 413 is rotationally driven by the sub-scanning motor 416 via a timing belt 417 and a timing pulley 418.

At one side in the main-scanning direction K of the carriage 403, a maintenance recovery mechanism 420 that maintains and recovers the liquid discharge head 100 in good condition is disposed on a lateral side of the conveyance belt 412.

The maintenance recovery mechanism 420 includes, for example, a cap member 421 to cap a nozzle surface (surface on which a nozzle is formed) of the liquid discharge head 100, a wiper member 422 to wipe the nozzle surface, and the like.

The main-scanning moving mechanism 493, the maintenance recovery mechanism 420, and the conveyance mechanism 495 are mounted to a housing that includes side plates 491A and 491B and a back plate 491C.

In the liquid discharge apparatus 500 thus configured, the sheet 410 is fed onto and attracted to the conveyance belt 412, and the sheet 410 is conveyed in the sub-scanning direction L by a cyclic rotation of the conveyance belt 412.

The liquid discharge head 100 is driven in response to image signals while the carriage 403 moves in the main-scanning direction K, to discharge liquid to the sheet 410 stopped, thus forming an image on the sheet 410.

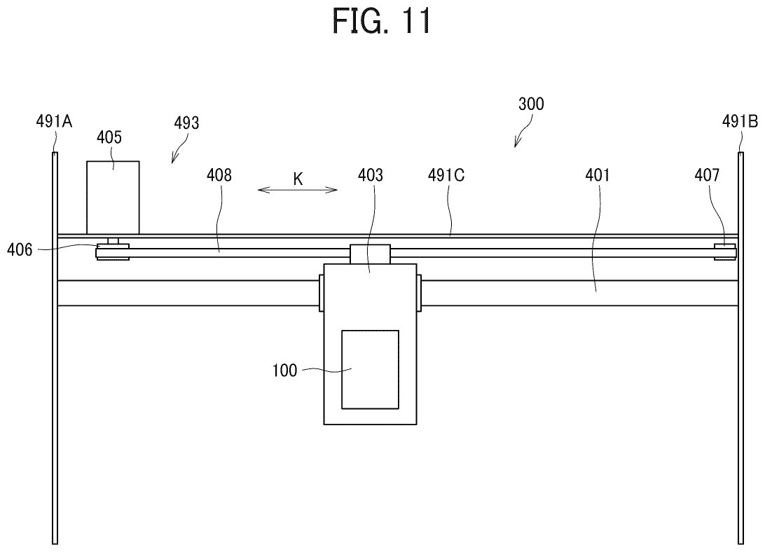

Next, another example of the liquid discharge unit according to the present embodiment is described referring to FIG. 11. FIG. 11 is an explanatory plan view of a main part of the liquid discharge unit.

The liquid discharge unit 300 includes a housing part including the side plates 491A and 491B and the back plate 491C, the main-scanning moving mechanism 493, the carriage 403, and the liquid discharge head 100 among members constituting the liquid discharge apparatus.

Note that, the liquid discharge unit may be configured such that the maintenance recovery mechanism 420 described above is further mounted on the side plate 491B, for example, of the liquid discharge unit 300.

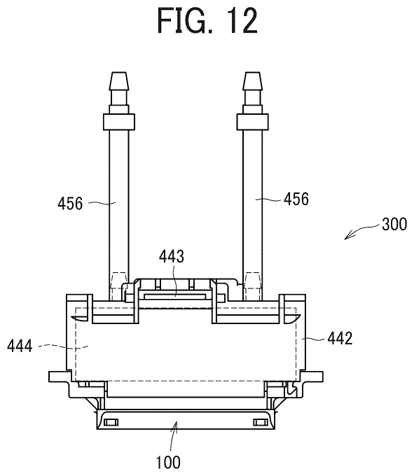

Next, still another example of the liquid discharge unit according to the present embodiment is described referring to FIG. 12. FIG. 12 is an explanatory front view of the liquid discharge unit.

The liquid discharge unit 300 includes a liquid discharge head 100 to which a channel component 444 is attached, and a tube 456 coupled to the channel component 444.

The channel component 444 is disposed inside a cover 442. Alternatively, the head tank 441 (see FIG. 10) can also be included instead of the channel component 444. A connector 443 electrically coupled with the liquid discharge head 100 is provided on an upper part of the channel component 444.

The above-described liquid discharge head 100 can also be provided in the liquid discharge unit and the liquid discharge apparatus described above. This makes it possible to improve liquid discharge stability.

In the present application, discharged liquid is not particularly limited as long as it has a viscosity or surface tension that can be discharged from the head. However, preferably, the viscosity of the liquid is 30 mPa's or less under ordinary temperature and ordinary pressure or by heating or cooling. Specific examples of the liquid include a solution, a suspension, or an emulsion including, for example, a solvent, such as water or an organic solvent, a colorant, such as dye or pigment, a functionality imparting material, such as a polymerizable compound, a resin, a surfactant, a biocompatible material, such as deoxyribonucleic acid (DNA), amino acid, protein, or calcium, and an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

Examples of an energy source for generating energy to discharge liquid include a piezoelectric actuator (a lamination piezoelectric element or a thin-film piezoelectric element), a thermal actuator that employs an electro-thermal conversion element, such as a thermal resistor, and an electrostatic actuator including a diaphragm and opposed electrodes.

The “liquid discharge unit” is an assembly of parts relating to liquid discharge. The term “liquid discharge unit” represents a structure including a functional component(s) or mechanism(s) combined with the liquid discharge head to form a single unit. For example, the “liquid discharge unit” includes a combination of the liquid discharge head with at least one of a head tank, a carriage, a supply mechanism, a maintenance recovery mechanism, or a main-scanning moving mechanism.

Examples of the “single unit” include a combination in which the liquid discharge head and one or more functional components and mechanisms are secured to each other through, e.g., fastening, bonding, or engaging, and a combination in which one of the liquid discharge head and the functional components and mechanisms is movably held by another. The liquid discharge head and the functional components or mechanisms may be detachably attached to each other.

For example, the liquid discharge head and the head tank are integrated to form the liquid discharge unit as a single unit. The liquid discharge head and the head tank may be integrated by being coupled with each other via a tube or the like. A unit including a filter may further be added to a portion between the head tank and the liquid discharge head of the liquid discharge unit.

The liquid discharge head and the carriage may be formed into a single unit as the liquid discharge unit.

The liquid discharge head is movably held on the guide member that constitutes a part of the scanning moving mechanism. Thus, the liquid discharge head and the scanning moving mechanism may be formed into a single unit to be the liquid discharge unit. The liquid discharge head, the carriage, and the main-scanning moving mechanism may form a single unit.

A cap member that forms a part of the maintenance recovery mechanism may be secured to the carriage mounting the liquid discharge head so that the liquid discharge head, the carriage, and the maintenance recovery mechanism are formed into a single unit as the liquid discharge unit.

Tubes are coupled to the head tank or the liquid discharge head with a channel part attached thereto so that the liquid discharge head and the supply mechanism are formed into a single unit as the liquid discharge unit.

The main-scanning moving mechanism may include a guide member. The supply mechanism includes a single tube and a single loading unit.

Although embodiments of the present embodiment have been described above, the present embodiment is not limited to the above-described embodiment, and various modifications can be made without departing from the gist of the present embodiment.

The term “liquid” includes not only ink but also paint.

In the present application, the “liquid discharge apparatus” includes the liquid discharge head or the liquid discharge unit and drives the liquid discharge head to discharge a liquid. The liquid discharge apparatus includes, in addition to apparatuses to discharge liquid to an object to which liquid can adhere, apparatuses to discharge the liquid into gas or liquid.

The “liquid discharge apparatus” may include a means regarding feeding, conveyance, and paper ejection of an object to which liquid can adhere, a pretreatment apparatus, and a posttreatment apparatus.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “object to which liquid can adhere” represents a material on which liquid can at least temporarily adhere, a material on which liquid adheres and is fastened, or a material into which liquid adheres and permeates. Specific examples of the “object to which liquid can adhere” include, but are not limited to, a recording medium such as a paper sheet, recording paper, a recording paper sheet, a film, or cloth, an electronic component such as an electronic substrate or a piezoelectric element, and a medium such as layered powder, an organ model, or a testing cell. The “object to which liquid can adhere” includes any medium to which liquid adheres, unless otherwise specified.

Examples of materials for the “object to which liquid can adhere” include any materials to which liquid can adhere even temporarily, such as paper, thread, fiber, fabric, leather, metal, plastic, glass, wood, and ceramic.

The “liquid discharge apparatus” may be an apparatus to relatively move the liquid discharge head and an object to which liquid can adhere. However, the liquid discharge apparatus is not limited to such an apparatus. Specific examples of the liquid discharge apparatus include a serial type apparatus that moves the liquid discharge head, and a line type apparatus that does not move the liquid discharge head.

Examples of the “liquid discharge apparatus” further include a treatment liquid applying apparatus that discharges a treatment liquid onto a sheet to apply the treatment liquid to the surface of the sheet for the purpose of modifying the surface of the sheet, and an ejection granulating apparatus that ejects a composition liquid in which a raw material is dispersed in a solution through a nozzle to granulate fine particles of the raw material.

A liquid discharge head (100, 200) includes: a nozzle plate (1) having a nozzle (4) configured to discharge liquid in a discharge direction (Z); a channel plate (2, 202) over the nozzle plate (1), the channel plate (2, 202) having: a pressure chamber (6); multiple flow restrictors (7, 207): each communicating with the pressure chamber common to each of the multiple flow restrictors (7, 207); overlapped with each other in the discharge direction; and each having a same length in a longitudinal direction (X) orthogonal to the discharge direction (Z); an individual chamber communicating with the pressure chamber (6) through the multiple flow restrictors (7, 207); and a pressure generator (12) configured to generate pressure in the pressure chamber (6).

The multiple flow restrictors (7, 207): overlap in a plan view of the channel plate (2, 202); and are disposed at a different position in the discharge direction (Z). The channel plate (2, 202) includes multiple lamination plates laminated one on another, and each of the multiple lamination plates has a recess or a through hole defining at least two of: the pressure chamber (6); the flow restrictor (7); or the individual chamber (66, 68), arranged in a direction orthogonal to the discharge direction. The at least two of: the pressure chamber (6); the flow restrictor (7); or the individual chamber (66, 68), are arranged in the longitudinal direction in each of the multiple lamination plates. A number of the multiple lamination plates is larger than the number of the multiple flow restrictors, and a subset of the multiple lamination plates has the multiple flow restrictor (7).

The multiple flow restrictors (7, 207) have: a first flow restrictor (7A) defined by the recess; and a second flow restrictor (7B) defined by the recess, the second flow restrictor (7B) disposed closer to the nozzle plate (1) than the first flow restrictor (7A) in the discharge direction (Z), and the multiple lamination plates (21-24) include: a first lamination plate (22) having the first flow restrictor (7A); a second lamination plate (23) having a partition to partition the first flow restrictor (7A) and the second flow restrictor (7B); and a third lamination plate (24) having the second flow restrictor (7B), and the second lamination plate (23) is disposed between the first lamination plate (22) and the third lamination plate (24).

Each of the multiple flow restrictors (7A, 7B) has a first width in a nozzle array direction orthogonal to the discharge direction and the longitudinal direction (Y); and the individual chamber (66, 68) has a second width larger than the first width in the nozzle array direction. Each of the multiple flow restrictors (7A, 7B) has a first height in the discharge direction (Z), and the individual chamber (66, 68) has a second height larger than the first height in the discharge direction. Each of the multiple flow restrictors (7A, 7B) has a first height in the discharge direction (Z), and the individual chamber (66, 68) has a second height larger than the first height in the discharge direction. Each of the first flow restrictor (7A) and the second flow restrictor (7B) has a first length (L1a, L1b) in the longitudinal direction, and the partition of the second lamination plate (23) has a second length (L2b) smaller than the first length (L1a, L2b) in the longitudinal direction. Each of the first flow restrictor and the second flow restrictor communicates with the pressure chamber common to each of the first flow restrictor and the second flow restrictor.

The first lamination plate (22) has: first multiple holes (62) arrayed in a nozzle array direction orthogonal to the discharge direction and the longitudinal direction, the first multiple holes (62) respectively forming multiple pressure chambers (6) including the pressure chamber (6); multiple recesses (7A) arrayed in the nozzle array direction, the multiple recesses (7A) respectively forming multiple first flow restrictors (7A) including the first flow restrictor; and second multiple holes (66) arrayed in the nozzle array direction, the second multiple holes (66) respectively forming multiple individual chambers (66) including the individual chamber (6); the third lamination plate (24) has: third multiple holes (64) arrayed in the nozzle array direction, the third multiple holes (64) respectively forming the multiple pressure chambers (6); multiple recesses (7B) arrayed in the nozzle array direction, the multiple recesses (7B) respectively forming multiple second flow restrictors (7B) including the second flow restrictor (7B); and fourth multiple holes (68) arrayed in the nozzle array direction, the fourth multiple holes (68) respectively forming the multiple individual chambers (68); and the second lamination plate (23) has: fifth multiple holes (63) arrayed in the nozzle array direction, the fifth multiple holes (63) respectively forming the multiple pressure chambers (6), the partition partitioning the multiple first flow restrictors (7A) and the multiple second flow restrictors (7B); and one hole (67) forming an intermediate chamber (67) communicating with each of the second multiple holes (66) of the first lamination plate (22) and the fourth multiple holes (68) of the third lamination plate (24) in the discharge direction. An image forming apparatus (500) includes the liquid discharge head (100, 200).

According to the present embodiment, liquid discharge stability can be improved.

The terms of image formation, recording, printing, image printing, print, and fabricating used in the present application may be used synonymously with each other.

The terms of image formation, recording, printing, image printing, print, and fabricating used in the present application may be used synonymously with each other.

Aspects of the present embodiment are, for example, as follows.

### Aspect 1

According to Aspect 1, a liquid discharge head includes:
a nozzle plate having a nozzle from which liquid is discharged;
a channel plate forming a pressure chamber, a flow restrictor that communicates with the pressure chamber, and an individual chamber that communicates with the flow restrictor on a side opposite to the pressure chamber inside the channel plate; and
a pressure generator configured to generate pressure in the pressure chamber,
the liquid being supplied from the individual chamber to the pressure chamber through the flow restrictor, and
in the channel plate, multiple the flow restrictors having the same length in a longitudinal direction of the flow restrictor being formed to overlap each other in a discharge direction, and the multiple flow restrictors communicating with the common pressure chamber.

### Aspect 2

According to Aspect 2, in the liquid discharge head of Aspect 1, the multiple flow restrictors is provided at the same position on a plane perpendicular to the discharge direction.

### Aspect 3

According to Aspect 3, in the liquid discharge head of Aspect 1 or 2,
the channel plate includes multiple lamination members stacked one on another, and
the flow restrictor and the individual chamber are defined side by side in the longitudinal direction by a recess in the lamination member.

### Aspect 4

According to Aspect 4, in the liquid discharge head of Aspect 3, the multiple flow restrictors is formed in different lamination members.

### Aspect 5

According to Aspect 5, in the liquid discharge head of Aspect 4,
the lamination member includes a first lamination member, a second lamination member, and a third lamination member,
the second lamination member is provided between the first lamination member and the third lamination member, and
the flow restrictor is formed by each of recesses in the first lamination member and the third lamination member, and the flow restrictor is partitioned by the second lamination member.

### Aspect 6

According to Aspect 6, in the liquid discharge head of any one of Aspects 1 to 5, the flow restrictor has a width in both a nozzle array direction and the discharge direction smaller than a width of the individual chamber.

### Aspect 7

According to Aspect 7, in the liquid discharge head of any one of Aspects 1 to 6,
the channel plate forms an intermediate supply chamber communicating with the plurality of individual chambers inside the channel plate, and
a length of the flow restrictor is longer than a distance between the intermediate supply chamber and the pressure chamber in the longitudinal direction of the flow restrictor.

### Aspect 8

According to Aspect 8, in the liquid discharge head of any one of Aspects 1 to 7, two of the flow restrictors communicate with one pressure chamber.

### Aspect 9

According to Aspect 9, an image forming apparatus includes the liquid discharge head of any one of Aspects 1 to 8.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having a nozzle configured to discharge liquid in a discharge direction;
a channel plate over the nozzle plate, the channel plate having:
a pressure chamber;
multiple flow restrictors:
each communicating with the pressure chamber common to each of the multiple flow restrictors;
overlapped with each other in the discharge direction; and
each having a same length in a longitudinal direction orthogonal to the discharge direction;
an individual chamber communicating with the pressure chamber through the multiple flow restrictors; and
a pressure generator configured to generate pressure in the pressure chamber.

2. The liquid discharge head according to claim 1,
wherein the multiple flow restrictors:
overlap in a plan view of the channel plate; and
are at a different position in the discharge direction.

3. The liquid discharge head according to claim 2,
wherein the channel plate includes multiple lamination plates laminated one on another, and
each of the multiple lamination plates has a recess or a through hole defining at least two of:
the pressure chamber;
the flow restrictor; or
the individual chamber,
arranged in a direction orthogonal to the discharge direction.

4. The liquid discharge head according to claim 3,
wherein the at least two of:
the pressure chamber;
the flow restrictor; or
the individual chamber,
are arranged in the longitudinal direction in each of the multiple lamination plates.

5. The liquid discharge head according to claim 4,
wherein a number of the multiple lamination plates is larger than the number of the multiple flow restrictors, and
a subset of the multiple lamination plates has the multiple flow restrictor.

6. The liquid discharge head according to claim 5,
wherein the multiple flow restrictors have:
a first flow restrictor defined by the recess; and
a second flow restrictor defined by the recess,
the second flow restrictor disposed closer to the nozzle plate than the first flow restrictor in the discharge direction, and
the multiple lamination plates include:
a first lamination plate having the first flow restrictor;
a second lamination plate having a partition to partition the first flow restrictor and the second flow restrictor; and
a third lamination plate having the second flow restrictor, and
the second lamination plate is disposed between the first lamination plate and the third lamination plate.

7. The liquid discharge head according to claim 2,
wherein each of the multiple flow restrictors has a first width in a nozzle array direction orthogonal to the discharge direction and the longitudinal direction; and
the individual chamber has a second width larger than the first width in the nozzle array direction.

8. The liquid discharge head according to claim 2,
wherein each of the multiple flow restrictors has a first height in the discharge direction, and
the individual chamber has a second height larger than the first height in the discharge direction.

9. The liquid discharge head according to claim 7,
wherein each of the multiple flow restrictors has a first height in the discharge direction, and
the individual chamber has a second height larger than the first height in the discharge direction.

10. The liquid discharge head according to claim 6,
wherein each of the first flow restrictor and the second flow restrictor has a first length in the longitudinal direction, and
the partition of the second lamination plate has a second length smaller than the first length in the longitudinal direction.

11. The liquid discharge head according to claim 6,
wherein each of the first flow restrictor and the second flow restrictor communicates with the pressure chamber common to each of the first flow restrictor and the second flow restrictor.

12. The liquid discharge head according to claim 6,
wherein the first lamination plate has:
first multiple holes arrayed in a nozzle array direction orthogonal to the discharge direction and the longitudinal direction, the first multiple holes respectively forming multiple pressure chambers including the pressure chamber;
multiple recesses arrayed in the nozzle array direction, the multiple recesses respectively forming multiple first flow restrictors including the first flow restrictor; and
second multiple holes arrayed in the nozzle array direction, the second multiple holes respectively forming multiple individual chambers including the individual chamber;
the third lamination plate has:
third multiple holes arrayed in the nozzle array direction, the third multiple holes respectively forming the multiple pressure chambers;
multiple recesses arrayed in the nozzle array direction, the multiple recesses respectively forming multiple second flow restrictors including the second flow restrictor; and
fourth multiple holes arrayed in the nozzle array direction, the fourth multiple holes respectively forming the multiple individual chambers; and
the second lamination plate has:
fifth multiple holes arrayed in the nozzle array direction, the fifth multiple holes respectively forming the multiple pressure chambers,
the partition partitioning the multiple first flow restrictors and the multiple second flow restrictors; and
one hole forming an intermediate chamber communicating with each of the second multiple holes of the first lamination plate and the fourth multiple holes of the third lamination plate in the discharge direction.

13. An image forming apparatus comprising the liquid discharge head according to claim 1.
